(19) United States
(12) Patent Application Publication
(10) Pub. No.: US 2020/0123352 A1
(43) Pub. Date: Apr. 23, 2020

(54) Oxygen scavenging formulation and method of scavenging oxygen

(71) Applicant: FOOD INDUSTRY RESEARCH AND DEVELOPMENT INSTITUTE, Hsinchu City (TW)

(72) Inventors: YU-CHI CHENG, HSINCHU CITY (TW); CHUN-FONG LIN, HSINCHU CITY (TW); YI-JHEN WU, HSINCHU CITY (TW); HSIU-HUNG JEN, HSINCHU CITY (TW); BINGHUEI BARRY YANG, HSINCHU CITY (TW)

(73) Assignee: FOOD INDUSTRY RESEARCH AND DEVELOPMENT INSTITUTE, HSINCHU CITY (TW)

(21) Appl. No.: 16/162,612

(22) Filed: Oct. 17, 2018

(51) Int. Cl. C08L 23/06; C08L 23/12; C08L 33/10; C08J 3/28; C08K 5/00; C08K 5/01; C08K 5/053; C08K 5/07; B65D 81/26; A23L 3/3436

(52) U.S. Cl. CPC C08L 23/06; C08L 23/12; C08L 33/10; C08J 3/28; C08K 5/0041; C08K 2201/012; C08K 5/053; C08K 5/07; B65D 81/267; A23L 3/3436; C08L 2203/16; C08K 5/01

(57) ABSTRACT

An oxygen scavenging formulation comprising an oxidizable polymer resin, a transition metal catalyst, and a photosensitizer selected from one or more carotenoids is provided. The oxygen scavenging formulation does not need an additional triggering agent, or heating or light irradiation to trigger an oxygen scavenging function. A method of reducing oxygen atmosphere in a packaging article is also provided.

### FIELD OF THE INVENTION

The invention relates to an oxygen scavenging formulation, whose oxygen scavenging function does not need to be triggered with by an additional triggering agent, or heating or light irradiating. In particular, the formulation comprises an oxidizable polymer resin, a transition metal catalyst, and a photosensitizer selected from one or more carotenoids.

### BACKGROUND OF THE INVENTION

Oxygen scavenging packaging technology has been widely used in the food packaging industry. Most oxygen sensitive products deteriorate in the presence of oxygen, including food products such as meat and cheese, smoked and processed luncheon meats, as well as non-food products such as electronic components, pharmaceuticals and medical products. Limiting exposure to oxygen provides a means to maintain and enhance quality and shelf life of packaged products, especially in the food industry. Thus, removal of oxygen from packaged products and creating barriers against oxygen penetration during storage is an important objective for packaging technology.

Several techniques have been developed to limit exposure to oxygen of sensitive packaged materials. Such techniques include the use of barrier materials with low permeability to oxygen as a part of the packaging; the inclusion of items capable of consuming oxygen other than the packaging materials (through the use of sachets with a material capable of reacting with oxygen); and the creation of a reduced oxygen environment within the package (e.g., modified atmosphere packaging (MAP) and vacuum packaging). While each of the above techniques has its place in the industry, it is well recognized that the inclusion of an oxygen scavenger as a part of the packaging article is one of the most desirable means to limit oxygen exposure.

In the late 1970s, the free-oxygen agent Ageless®, developed by Mitsubishi Gas Chemical Company, Inc. in Japan, was introduced to commercial applications, in the form of an oxygen scavenging sachet, label sticker, or component of the food packaging material itself. The principle of oxygen scavenging relies on the reaction between an oxygen scavenger and oxygen. In the previously developed scavengers, a distinction can be made between iron-based, sulfite-based, ascorbate-based and enzyme-based systems as well as oxidizable polyamides and ethylenically unsaturated hydrocarbons. These oxygen scavengers preferably can effectively reduce the oxygen content in a package to less than 0.01% of the air. In comparison with an MAP, such as vacuum packaging or nitrogen filling technology, in which the oxygen content only can be reduced to 0.3-3%, the oxygen scavenging effect is more pronounced. However, oxygen scavengers need to be triggered, for example, with water, high temperature or light to activate an oxygenation reaction. Iron-based scavengers are based on the oxidation of metallic irons to iron(II) hydroxide and iron(III) hydroxide. The reaction requires, in addition to certain promoters that have an accelerating action, moisture in order to start the scavenging process. This creates a trigger mechanism that makes purposeful activation possible. However, such scavengers are suitable only for products with a high moisture content. Furthermore, general disadvantages when using such powdery scavengers in polymer sheets are reduced transparency and deterioration of the mechanical properties of these sheets. In the absence of a trigger agent or process, the oxygen scavenging effect cannot be initiated. In yet another aspect, the trigger agent may directly be added to packaging materials so as to produce self-triggering oxygen scavenging packaging materials.

Conventionally, triggering processes require high temperature or ultraviolet light to provide a specific amount of energy to activate the oxygen scavenging function of a double bond containing polymer. For example, U.S. Pat. No. 5,911,910 A discloses that after a packaging film produced from an oxidizable organic compound, such as an unsubstituted or substituted ethylenically unsaturated hydrocarbon polymer, is exposed to an ultraviolet light with an intensity greater than 100 mJ/cm² and heated to a temperature of 65 to 80° F. in a chamber, the oxygen scavenging function of the oxidizable organic compound can be triggered. U.S. Pat. No. 6,610,215 B discloses a heat-activated oxygen scavenging formulation comprising an oxidizable organic compound, such as a cyclic olefin compound, for example, an ethylene-methyl cyclohexene copolymer or an ethylene-methyl acrylate/cyclohexenyl methyl acrylate terpolymer, and a transition metal catalyst. The oxygen scavenging formulation can be used in bags and films having a single- or multi-layer structure. The oxygen scavenging function can be triggered by heating the oxygen scavenging formulation to a temperature of 75 to 300° C. for more than 60 minutes.

U.S. Pat. No. 7,468,144 B2 discloses a process of thermally triggering an oxygen scavenging formulation comprising an oxidizable organic compound and a transition metal by using a peroxide, such as hydrogen peroxide. The process includes wetting the surface of a packaging article made from the oxygen scavenging formulation with a 2% hydrogen peroxide solution; then, exerting 70° C. hot air to remove the excess hydrogen peroxide solution; and finally exposing the article to ultraviolet light to trigger the oxygen scavenging function. The results show that the pretreatment of the packaging article with a peroxide can enhance the oxygen scavenging effect caused by the oxidizable organic compound.

Triggering agents have also been widely studied in the art. For example, U.S. Pat. No. 6,139,770A discloses that the triggering agent may be a photoinitiator comprising a benzophenone derivative containing at least two benzophenone moieties, such as tribenzoyl triphenylbenzene and substituted tribenzoyl triphenylbenzene, and that the oxygen scavenging formulations containing such a photoinitiator can be activated by ultraviolet or visible light having a wavelength in the range of from about 200 nm to about 750 nm, electron beam, or thermal triggering. U.S. Pat. No. 7,153,891 B2 discloses that the triggering agent may be a photoinitiator comprising one or more materials selected from the group consisting of isopropylthioxanthone, 2,4-diethylthioxanthone, 2-chlorothioxanthone, and -chloro-4-propoxythioxanthone, and that the oxygen scavenger formulations comprising such photoinitiators can be triggered by a dosage of actinic radiation of a germicidal lamp having a principal emission wavelength of 254 nanometers.

Typical double bond containing polymer based oxygen scavengers need to be triggered by exposure to light or heating to a high temperature. However, since a heating process not only takes much time but also is limited to a specific processing temperature range of the packaging, material, it is particularly unsuitable for a multilayer packaging film that has been coated, printed or heat sealed. On the other hand, for a radiation-triggered oxygen scavenger, a food-processing factory would need to additionally purchase a high-intensity UV irradiation equipment, incurring further capital expenditures.

Therefore, although a variety of approaches to trigger the oxygen scavenging, function of a packaging article have been developed, there still remains a need for improving the oxygen scavenging formulation and the packaging materials utilizing the same.

### SUMMARY OF THE INVENTION

The present invention provides an improved oxygen scavenging formulation, in which the oxygen scavenging function does not need to be triggered with an additional triggering agent or by heating or light irradiating, and an article made therefrom.

Therefore, one aspect of the invention is directed to an oxygen scavenging formulation, which comprises an oxidizable polymer resin, a transition metal catalyst, and a photosensitize selected from one or more carotenoids.

Another aspect of the invention is directed to a method of reducing oxygen atmosphere in a packaging article, which comprises providing an oxygen scavenging formulation to the packaging article to allow the oxygen scavenging formulation to contact oxygen and reduce the oxygen atmosphere in the packaging article, wherein the oxygen scavenging formulation comprises an oxidizable polymer resin, a transition metal catalyst, and a photosensitizer selected from one or more carotenoids.

A further aspect of the invention is directed to a method of reducing oxygen atmosphere in a packaging article, which comprises the steps of a) exposing an oxygen scavenging formulation to UV radiation to trigger oxygen scavenging, wherein the oxygen scavenging formulation comprises an oxidizable polymer resin, a transition metal catalyst, and a photosensitizer selected from one or more carotenoids; and b) providing the triggered oxygen scavenging formulation to the inside of the packaging article to allow the oxygen scavenging formulation to contact oxygen and reduce the oxygen atmosphere in the packaging article.

A further aspect of the invention is directed to a method of reducing oxygen atmosphere in a packaging article, which comprises the steps of a) exposing a multilayer packaging film comprising an oxygen scavenging film to UV radiation to trigger oxygen scavenging, wherein the oxygen scavenging film is composed of an oxygen scavenging formulation comprising an oxidizable polymer resin, a transition metal catalyst, and a photosensitizer selected from one or more carotenoids; and b) sealing the multilayer packaging film to form the packaging article to allow the oxygen scavenging formulation to contact oxygen and reduce the oxygen atmosphere in the packaging article.

### BRIEF DESCRIPTION OF THE DRAWINGS

FIGS. 1-(a) and (b) respectively illustrate the change of the oxygen concentration and the amount of oxygen being reduced in an 11 ml gas-sealed bottle with respect to scavenging time for a blank film and oxygen scavenger films containing 1 wt % benzophenone or 1 wt % β-carotene.

FIGS. 2-(a) and (b) respectively illustrate the change of the oxygen concentration and the amount of oxygen being reduced in an 11 ml gas-sealed bottle with respect to scavenging time for an oxygen scavenger film containing 1 wt % β-carotene under exposure to UVC light with various energy densities.

FIGS. 3-(a) and (b) respectively illustrate the change of the oxygen concentration and the amount of oxygen being reduced in an 11 ml gas-settled bottle with respect to scavenging time for oxygen scavenger films containing various amounts of β-carotene.

FIG. 4 illustrates the change of the oxygen concentration in an 11 ml gas-sealed bottle with respect to scavenging time for a film containing 1 wt % β-carotene, lycopene, retinol, or astaxanthin.

### DETAILED DESCRIPTION OF THE INVENTION

The present invention can be understood more readily by reference to the following detailed description of various embodiments of the invention, the examples, and the tables with their relevant descriptions. Unless otherwise defined, all terms (including technical and scientific terms) used herein have the same meaning as commonly understood by one of ordinary skill in the art to which this invention belongs. It will be further understood that terms such as those defined in commonly used dictionaries should be interpreted consistently with their meaning in the context of the relevant art and will not be interpreted in an idealized or overly formal sense unless expressly so defined herein. It is also to be understood that the terminology used herein is for the purpose of describing particular embodiments only, and is not intended to be limiting.

It must be noted that, as used herein, the singular forms “a,” “an” and “the” include plural referents unless the context clearly dictates otherwise. Thus, unless otherwise required by context, singular terms shall include the plural, and plural terms shall include the singular.

The word “or” in reference to a list of two or more items covers all of the following interpretations of the word: any of the items in the list, all of the items in the list, and any combination of the items in the list.

Often, ranges are expressed herein as from “about” one particular value and/or to “about” another particular value. When such a range is expressed, an embodiment includes the range from the one particular value and/or to the other particular value. Similarly, when values are expressed as approximations, by use of the word “about,” it will be understood that the particular value forms another embodiment. It will be further understood that the endpoints of each of the ranges are significant both in relation to and independently of the other endpoint. As used herein, the term “about” refers to ±20%, preferably±10%, and even more preferably ±5%.

Unless the context clearly requires otherwise, throughout the description and the claims, the words “comprise,” “comprising” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application.

“Reduced oxygen atmosphere” or “reducing oxygen atmosphere” refers to a reduction in the partial pressure of oxygen in a packaging article, in comparison with the partial pressure of oxygen in the Earth's atmosphere at standard temperature and pressure at sea level. Reduced oxygen atmosphere packages may include modified atmosphere packages where the oxygen partial pressure is less than that of the Earth's atmosphere at standard temperature and pressure at sea level.

In accordance with the present invention, a “packaging article” refers to an object of manufacture which can be in the form of a web, e.g., monolayer or multilayer films, monolayer or multilayer sheets, containers, bags, shrink bags, pouches, casings, trays, lidded trays, overwrapped trays, thrill shrink packages, vacuum skin packages, flow wrap packages, thermoformed packages, packaging inserts or combinations thereof. It will be appreciated by those skilled in the art that, in accordance with the present invention, packaging articles may include flexible, rigid, or semirigid materials and may be heat shrinkable or not, or oriented or non-oriented.

An “intermediate layer,” as used herein, refers to a layer positioned between and in contact with at least two other layers.

An “outer layer,” as used herein is a relative term and need not be a surface layer.

The term “exterior layer” refers to a layer comprising the outermost surface of a film or product. For example, an exterior layer can form the exterior surface of a package that contacts the exterior layer of another package during overlapping heat sealing of two packages.

The term “interior layer” refers to a layer comprising the innermost surface of a film or product. For example, an interior layer forms the interior surface of an enclosed package. The interior layer can be the food contact layer and/or the sealant layer.

The term “adhesive layer” refers to a layer or material placed on one or more layers to promote the adhesion of that layer to another surface. Preferably, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may comprise components of both the first layer and the second layer to promote simultaneous adhesion of the adhesive layer to both the first layer and the second layer to opposite sides of the adhesive layer.

As used herein, the terms “seal layer, ” “sealing layer,” “heat seal layer, ” and “sealant layer” refer to an outer film layer, or layers, involved in the sealing of the flint to itself; to another film layer of the same film or another film; and/or to another article which is not a film, e.g., a tray. In general, the sealant layer is an interior layer of any suitable thickness, that provides for the sealing of the film to itself or another layer. With respect to packages having only fin-type seals, as opposed to lap-type seals, the term “sealant layer” generally refers to the interior surface film layer of a package. The inside layer frequently can also serve as a food contact layer in the packaging of foods.

“Food contact layer” refers to the portion of a packaging material that contacts a packaged food product.

In an embodiment, the present invention provides an oxygen scavenging formulation comprising an oxidizable polymer resin, a transition metal catalyst, and a photosensitizer selected from one or more carotenoids.

In a preferred embodiment of the present invention, the oxidizable polymer resin may comprise a double bond containing olefinic compound, such as
(i) homo and copolymers of olefin monomers such as ethylene and propylene, but also higher 1-olefins such as 1-butene, 1-pentene, 1-hexene or 1-octen. Preferred is polyethylene LDPE and LLDPE, HDPE and polypropylene;
(ii) homo- and copolymers of olefin monomers with diolefin monomers such as butadiene, isoprene and cyclic olefins such as norbornene; or
(iii) copolymers of one or more 1-olefins and/or diolefins weigh carbon monoxide and/or with other vinyl monomers, including, but not limited to, acrylic acid and its corresponding acrylic esters, methacrylic acid and its corresponding esters, vinyl acetate, vinyl alcohol, vinyl ketone, styrene, maleic acid anhydride and vinyl chloride.
   More preferably, the oxidizable polymer resin used in the invention may be polybutadiene or styrene-butadiene copolymers.

A transition metal catalyst is added to the oxygen scavenging formulation to prompt the oxidation reaction of the oxidizable polymer resins. The transition metal catalyst makes the formulation an “activated oxygen” scavenging formulation. The transition metal catalyst can be a salt that includes a metal selected from the first, second, or third transition series of the Periodic Table. The metal preferably is Rh, Ru, or one of the elements in the series of Sc to Zn (i.e., Sc, Ti, V, Cr, Mn, Fe, Co, Ni, Cu, and Zn), more preferably at least one of Mn, Fe, Co, Ni, and Cu, and most preferably Co. Suitable anions for such salts include, but are not limited to, chloride, acetate, octoate, oleate, stearate, palmitate, 2-ethylhexanoate, neocaprate, decanoate, neodecanoate, and naphthenate. Examples for the use of these salts are given in U.S. Pat. No. 3,840,512 and U.S. Pat. No. 4,101,720, such as cobalt neocaprate.

In an embodiment of the present invention, carotenoids may be used as a photosensitizer to trigger the oxygen scavenging function. The carotenoid is preferably selected from the group consisting of lycopene, zeaxanthine, retinol, cantaxanthine, α-, β-, γ- & δ-carotenes, astacin, astaxanthin, chrysanthemaxanthin, torularhodin, violaxanthin, capsanthin, capsorubin, riboflavin, xanthophyll, lutein, and any combination thereof, and more preferably is β-carotene.

According to the invention, based on the weight of the oxidizable polymer resin, the amount of the transition metal catalyst can be about 0.001 to about 5 wt %, preferably about 0.01 to about 4 wt %, and more preferably about 0.1 to about 2 wt %; and the amount of the photosensitizer ranges from about 0.5 to about 5 wt %, preferably about 0.75 to about 4 wt %, and more preferably about 1 to about 3 wt %.

Although not required, additives may be used in the oxygen scavenging formulation. Conventional known additives include, but are not limited to (i) fillers and reinforcing agents such as calcium carbonate, silicas, glass fibres, glass bulbs, talc, kaolin, mica, barium sulfate, metal oxides and hydroxides, carbon black, graphite, wood flour, flours of other natural products, synthetic fibers, stearates used as fillers such as calcium stearate on zinc stearate; (ii) pigments such as carbon black, titanium dioxide in its rutile or anatase forms, and other color pigments; (iii) light stabilizers and/or antioxidants; and (iv) processing additives such as antislip/antiblock additives, plasticizers, optical brighteners, antistatic, agents and blowing agents.

In a process of producing the oxygen scavenging formulation of the present invention, the transition metal catalyst, the photosensitizer and the optional additives can be admixed with the oxidizable polymer resin either simultaneously or in succession, or also immediately prior to the actual processing step.

The oxygen scavenging formulation of the present invention may be in the form of an oxygen scavenging film and the oxygen scavenging film may be coated onto a substrate by dry or wet spraying or dusting or by roll coating or coating using a Mayer bar or doctor blade, or by printing means (e.g., using gravure or flexography printing) or by using electrostatic transfer.

The oxygen scavenging formulations according to the present invention can be used to manufacture packaging articles, such as mono- or multilayer plastic films, sheets, laminates, bags, bottles, styrofoam cups, utensils, blister packages, boxes, and package wrappings. The packaging articles may be manufactured by any process available to those of ordinary skill in the art including, but not limited to, extrusion, extrusion blowing, film casting, film blowing, calendering, injection molding, blow molding, compression molding, thermoforming, spinning, blow extrusion, and rotational casting.

The packaging article may be a multilayer food packaging which comprises an exterior layer, a food contact-layer and an oxygen scavenging film. The exterior layer utilizes polyolefin resins, preferably a blend of (i) EVA, (ii) EAO (such as VLDPE), and (iii) an ethylene-hexene-1 copolymer having an mp of 80 to 98° C. The food contact layer is an interior layer and may also serve as a sealant layer. Suitable materials for use in the food contact layer should be thermally stable in excess of 150° C., and should meet all FDA guidelines for contact with aqueous and fatty foods under all conditions experienced during packaging, storage and cooking. Examples of food contact layer include polyesters, acrylics, and silicones. The preferred food contact layer is a polypropylene (PP) layer.

The multilayered food packaging article may further comprise an intermediate layer disposed between the oxygen scavenging film and the exterior layer and/or between the oxygen scavenging film and the food contact layer. A common suitable intermediate layer is an adhesive layer on either side of the oxygen scavenging film to connect with the exterior or food contact layer. One preferred component of the adhesive layer is EMAC SP 1330 and polyturethane (PU).

In an embodiment of the present invention, the multilayer packaging film for food packaging may be produced by coating the oxygen scavenging formulation on a plastic substrate to produce an oxygen scavenging film. After drying, the oxygen scavenging film can be attached to a food contact layer comprising an adhesive. The multilayer packaging film for food packaging may also be produced by coating the oxygen scavenging formulation on a food contact layer to produce an oxygen scavenging film. Then, the oxygen scavenging film can be attached to a printed exterior layer comprising an adhesive. Thereafter, the produced multilayer packaging film for food packaging comprising an exterior layer, a food contact layer, an oxygen scavenging film, and optionally an adhesive layer as an intermediate layer should be rolled to prevent the oxygen scavenging film from contact with oxygen.

One of the advantages of the oxygen scavenging formulation of the present invention is that it does not need to be triggered with water or by high temperature or light to activate an oxygenation reaction. However, a typical UV-light or pulsed-light triggering process may prompt the oxygenation reaction of the oxygen scavengers. Therefore, the invented oxygen scavenging formulations are also suitable for any conventional light-triggering processes or systems.

In view of the above, the present invention also provides a method of reducing oxygen atmosphere in a packaging article, which comprises providing an oxygen scavenging formulation to the packaging article to allow the oxygen scavenging formulation to contact oxygen, wherein the oxygen scavenging formulation comprises an oxidizable polymer resin, a transition metal catalyst, and a photosensitizer selected from one or more carotenoids.

The present invention also provides a method of reducing oxygen atmosphere in a packaging article, which comprises a) exposing an oxygen scavenging formulation to UV radiation to trigger the oxygen scavenging, wherein the oxygen scavenging formulation comprises an oxidizable polymer resin, a transition metal catalyst; and b) providing the triggered oxygen scavenging formulation to the inside of the packaging article to allow the oxygen scavenging formulation to contact oxygen and reduce the oxygen atmosphere in the packaging article.

The present invention further provides a method of reducing oxygen atmosphere in a packaging article. Which comprises the steps of a) exposing a multilayer packaging comprising an oxygen scavenging film to UV radiation to trigger oxygen scavenging; wherein the oxygen scavenging film is composed of an oxygen scavenging formulation comprising an oxidizable polymer resin, a transition metal catalyst, and a photosensitizer selected from one or more carotenoids; and b) sealing the multilayer packaging film to form the packaging article to allow the oxygen scavenging formulation to contact oxygen and reduce the oxygen atmosphere in the packaging article.

According to the invention, the exposing step comprises exposing the oxygen scavenging formulation to the UV radiation with an energy density of the Ultraviolet C (UVC) band from about 250 mJ/cm² to 600 mJ/cm³, preferably from about 350 mJ/cm² to 600 mJ/cm², more preferably from about 450 mJ/cm² to 600 mJ/cm².

In an embodiment of the invention, the oxygen scavenging formulation is present on the interior layer of the packaging article.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize.

### EXAMPLES

### Example 1

### Preparation of a Multi-Layer Structure Comprising an Oxygen Scavenging Film

To prepare a β-carotene-containing oxygen scavenging formulation, 0.03 g β-carotene (1 wt %) was added to 9 g a butyl acetate solvent, and the resulted solution was heated to dissolve β-carotene. With continuous stirring and heating, 3 g styrene-butadiene-styrene and 0.03 g cobalt neocaprate (1 wt %) were then added to the solution so as to obtain an oxygen scavenging formulation containing 1 wt % β-carotene. (The above weight percentages were calculated based on the total weight of styrene-butadiene-styrene.) The formulation was coated on a terephthalate (PET) substrate by using a scraper. The coated PET substrate was dried at 80° C. so that the oxygen scavenging formulations on the PET substrates became oxygen scavenging films with a thickness of 45 μm.

Comparative films were prepared in accordance with the process described above, where a blank film without the addition of β-carotene was obtained, and a benzophenone-containing oxygen scavenging film was obtained by replacing β-carotene with 0.03 g benzophenone wt % based on the total weight of styrene-butadiene-styrene).

### Example 2

### Exposure to UV Lamp

The β-carotene-containing film, blank film, and benzophenone-containing film prepared in Example 1 were cut into pieces with an area of 9 cm². The surface coated with the formulation of each of the films was then exposed to a 400 W UV lamp with an intensity distribution profile listed in Table 1 for 10 second at a distance of 7 cm:

TABLE 1

| Electromagnetic band | Power density |
|---|---|
| (wavelength) | (mW/cm²) |
| VIS band (400-800 nm) | 28 |
| UVA band (320-400 nm) | 26 |
| UVB band (275-320 nm) | 24 |
| UVC band (200-275 nm) | 19 |
| Total bands (200-800 nm) | 97 |

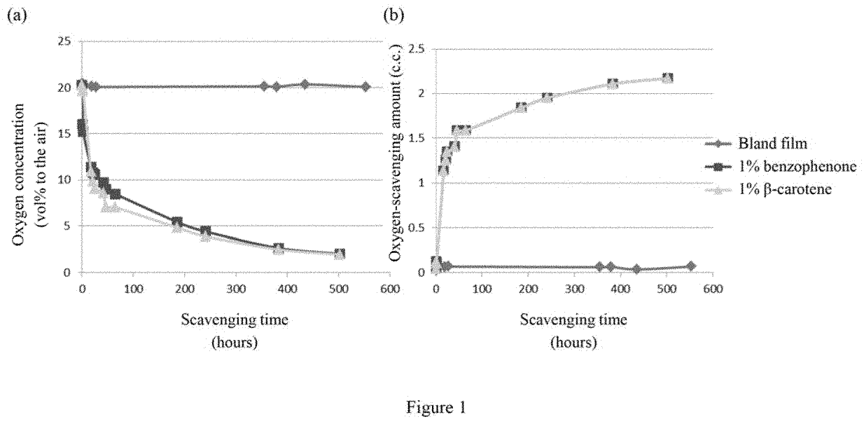

After exposure, the films were separately placed in 11 ml gas-tight bottles. The concentration of oxygen in each of the bottles was measured by a gas chromatograph (Trace 1310) in intervals. As shown in FIG. 1, the oxygen scavenging effect of both of the films containing 1 wt % β-carotene or 1 wt % benzophenone can be triggered by exposure to UV light for 30 second. In addition, the oxygen scavenging effect achieved by the oxygen scavenging film containing 1 wt % β-carotene is similar to that achieved by the oxygen scavenging film containing 1 wt % benzophenone (a conventional triggering agent) within five hundred hours. The above results prove that the conventionally used triggering agent, benzophenone, can be replaced by natural and water insoluble β-carotene.

### Example 3

### The Influence of the Energy Density of Ultraviolet C Light

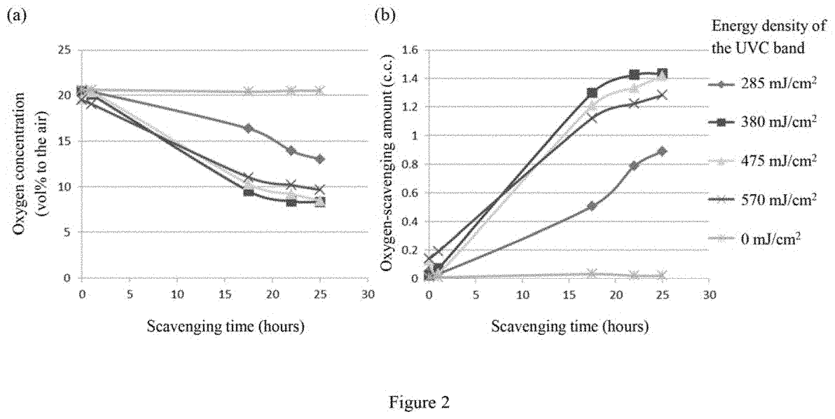

The oxygen scavenging film containing 1 wt % β-carotene prepared in Example 1 was separately exposed to a 400 W UV lamp with a UVC power density of 19 mV/cm² for 0, 15, 20, 25 or 30 seconds. The energy density of the UVC band (mJ/cm²) thus can be computed by multiplying the power density (19 mV/cm²) with the exposure time (0, 15, 20, 25 or 30 sec). Similarity, the exposed films were separately placed in 11 ml gas-tight bottles. The concentration of oxygen in each of the bottles was measured by gas chromatography (Trace 1310) in intervals. As shown in FIGS. 2(a) and 2(b), the oxygen scavenging effect of the oxygen scavenging film containing 1 wt % of β-carotene can be triggered within twenty-five hours when an oxygen scavenging film containing 1 wt % β-carotene is exposed to UVC light with an energy density of 285 mJ/cm² or higher.

### Example 4

### The Influence of the Amount of β-Carotene

0.015 g, 0.03 g and 0.09 g β-carotene (0.5 wt %, 1 wt % or 3 wt %) were respectively added to a 9 g butyl acetate solvent, and the resulting solutions were heated to dissolve β-carotene. With continuous stirring and heating, 3 g styrene-butadiene-styrene and 0.03 g cobalt neocaprate (1 wt %) were then added to each of the solutions so as to obtain three oxygen scavenging formulations respectively containing 0.5 wt %, 1 wt % and 3 wt % β-carotene. (The above weight percentages were calculated based on the total weight of styrene-butadiene-styrene.) The formulations were coated on a terephthalate (PET) substrate by using a scraper. The coated PET substrates were dried at 80° C. so that the oxygen scavenging formulations on the PET substrates became oxygen scavenging films with a thickness of 45 μm.

The oxygen scavenging films containing 0.5 wt %, 1 wt % and 3 wt % and β-carotene were cut into pieces with an area of 9 cm², and the surface coated with the oxygen scavenging formulation was exposed to a 400 W UV lamp with a power density of the UVC band of 19 mW/cm² for 30 sec (equivalent to an energy density of 570 mJ/cm²) at a distance of 7 cm. After exposure, the films were separately placed in 11 ml gas-tight bottles. The concentration of oxygen in each of the bottles was measured by gas chromatography (Trace 1310) in intervals.

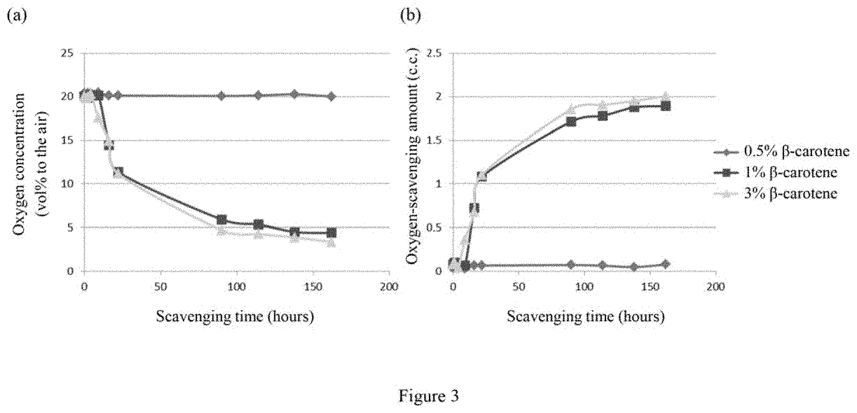

As shown in FIGS. 3(a) and 3(b), after being triggered with UVC light with an energy density of 570 mJ/cm², the films containing 1 wt % or more β-carotene can exhibit an oxygen scavenging effect within fifty hours.

### Example 5

### The Preparation of an Oxygen Scavenging Package

0.009 g, 0.03 g and 0.09 g β-carotene 0.3 wt %, 1 wt % or 3 wt %) were respectively added to a 9 g butyl acetate solvent, and the resulted three solutions were heated to dissolve β-carotene. With continuous stirring and heating, 3 g styrene-butadiene-styrene and 0.03 g cobalt neocaprate (1 wt %) were then added to the solutions so as to obtain β-carotene-containing oxygen scavenging formulations. (The above weight percentages were calculated based on the total weight of styrene-butadiene-styrene.) The formulations were then respectively coated on a polypropylene (PP) substrate by using a scraper. The coated PP substrates were dried at 80° C. so that the oxygen scavenging formulations on the PP substrates became oxygen scavenging films with a thickness of 25 μm. A #6 coating rod was used to coat a polyurethane (PU) adhesive on a polyethylene terephthalate (PET) substrate. After the coated PET substrate was dried, the PU-adhesive side of the PET substrate was attached to the oxygen scavenging film of each of the PP substrates to form a lamina. The formed laminas were independently put into aluminum foil bags.

The produced laminas were cut into pieces with a size of 3×3 cm². The PP substrates of two laminar pieces from the same laminar were arranged to face each other, and the two laminar pieces were sealed to form a package. Then, 11 ml of air was injected into each of the packages. The concentration of oxygen in the packages was measured by gas chromatography (Trace 1310) in intervals. The results are shown in Table 2:

TABLE 2

| | Oxygen concentration in the | | |
|---|---|---|---|
| | packages (vol % to the air) | | |
| Time | 0.3 wt % | 1 wt % | 3 wt % |
| (Day) | β-carotene | β-carotene | β-carotene |
| 2 | 20.0 | 20.1 | 20.1 |
| 4 | 20.0 | 20.0 | 13.1 |
| 7 | 20.1 | 20.0 | 9.5 |
| 8 | 20.1 | 20.0 | 7.3 |

The above results show that when the amount of β-carotene is 3 wt % or more based on the weight of styrene-butadiene-styrene, the oxygen scavenging formulations can significantly reduce the concentration of oxygen in the packages without using a triggering agent, or heating or light.

### Example 6

### Other Carotenoids

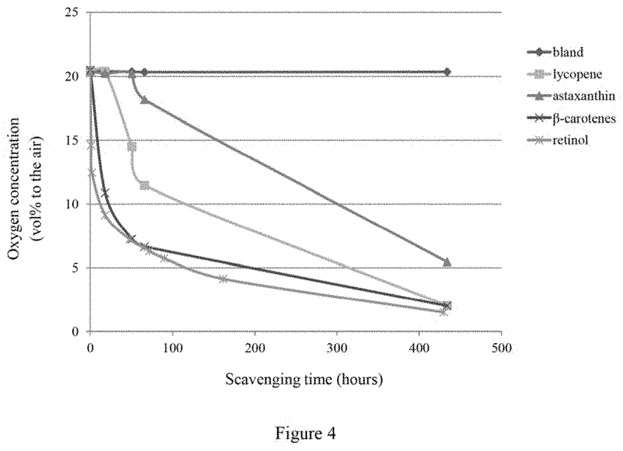

The films each containing 1 wt % β-carotene, lycopene, retinol, or astaxanthin were prepared in accordance with the process described in Example 1 and then was exposed to the 400 W UV lamp described in Example 2 for 30 second at a distance of 7 cm. As shown in FIG. 4, the oxygen scavenging effect can be triggered by all of the films containing 1 wt % of ditlemnt carotenoids, respectively.

What is claimed is:

1. An oxygen scavenging formulation, comprising an oxidizable polymer resin, a transition metal catalyst, and a photosensitizer selected from one or more carotenoids.

2. The oxygen scavenging formulation according to claim 1, wherein the carotenoid is lycopene, zeaxanthine, retinol, cantaxanthine, α-, β- γ- and δ-carotenes, astacin, astaxanthin, chrysanthemaxanthin, torularhodin, violaxanthin, capsanthin, capsorubin, riboflavin, xanthophyll or lutein.

3. The oxygen scavenging formulation according to claim 1, wherein the amount of the photosensitizer ranges from about 0.5 to about 5 wt % based on the weight of the oxidizable polymer resin.

4. The oxygen scavenging formulation according to claim 1, wherein the oxygen scavenging formulation is in the form of an oxygen scavenging film coated on a substrate.

5. The oxygen scavenging formulation according to claim 4, wherein the substrate is an exterior layer and/or an interior layer of a packaging article.

6. The oxygen scavenging formulation according to claim 5, wherein the packaging article further comprises an intermediate layer and/or an adhesive layer.

7. A method of reducing oxygen atmosphere in a packaging article, comprising providing an oxygen scavenging formulation to the packaging article to allow the oxygen scavenging formulation to contact oxygen and reduce the oxygen atmosphere in the packaging article, wherein the oxygen scavenging formulation comprises an oxidizable polymer resin, a transition metal catalyst, and a photosensitizer selected from one or more carotenoids.

8. The method according to claim 7, wherein the carotenoid is lycopene, zeaxanthine, retinol, cantaxanthine, α-, β- γ- and δ-carotenes, astacin, astaxanthin, chrysanthemaxanthin, torularhodin violaxanthin, capsanthin, capsorubin, riboflavin, xanthophyll or lutein.

9. The method according to claim 7, wherein the amount of the photosensitizer ranges from about 0.5 to about 5 wt % based on the weight of the oxidizable polymer resin.

10. A method of reducing oxygen atmosphere in a packaging article, comprising:
a) exposing an oxygen scavenging formulation to UV radiation to trigger oxygen scavenging, wherein the oxygen scavenging formulation comprises an oxidizable polymer resin, a transition metal catalyst, and a photosensitizer selected from one or more carotenoids; and
b) providing the triggered oxygen scavenging formulation to the inside of the packaging article to allow the oxygen scavenging formulation to contact oxygen and reduce the oxygen atmosphere in the packaging article.

11. The method according to claim 10, wherein the exposing step comprises exposing the oxygen scavenging formulation to the UV radiation with an energy density of the Ultraviolet C (UVC) band from about 250 mJ/cm² to 600 mJ/cm².

12. The method according to claim 10, wherein the carotenoid is lycopene, zeaxanthine, retinol, cantaxanthine, α-, β- γ- and δ-carotenes, astacin, astaxanthin, chrysanthemaxanthin, torularhodin, violaxanthin, capsanthin, capsorubin, riboflavin, xanthophyll or lutein.

13. The method according to claim 10, wherein the amount of the photosensitizer ranges from about 0.5 to about 5 wt % based on the weight of the oxidizable polymer resin.

14. The method according to claim 10, wherein the oxygen scavenging formulation is in a form of an oxygen scavenging film coated on a substrate.

15. A method of reducing oxygen atmosphere in a packaging article, comprising:
a) exposing a multilayer packaging film comprising an oxygen scavenging film to UV radiation to trigger oxygen scavenging, wherein the oxygen scavenging film is composed of an oxygen scavenging formulation comprising an oxidizable polymer resin, a transition metal catalyst, and a photosensitizer selected from one or more carotenoids: and
b) sealing the multilayer packaging film to form the packaging article to allow the oxygen scavenging formulation to contact Oxygen and reduce the oxygen atmosphere in the packaging article.

16. The method according to claim 15, wherein the exposing step comprises exposing the oxygen scavenging, film to the UV radiation with an energy density of the Ultraviolet C (UVC) hand from about 250 mJ/cm² to 600 mJ/cm².

17. The method according to claim 15, wherein the carotenoid is lycopene, zeaxanthine, retinol, cantaxanthine, α-, β- γ- and δ-carotenes astacin astaxanthin, chrysanthemaxanthin, torularhodin, violaxanthin, capsanthin, capsorubin, riboflavin, xanthophyll or lutein.

18. The method according to claim 15, wherein the amount of the photosensitizer ranges from about 0.5 to about 5 wt % based on the weight of the oxidizable polymer resin.

19. The method according to claim 15, wherein the multilayer packaging film further comprises an exterior layer, an interior layer, and optionally an adhesive layer.

20. The method according to claim 19, wherein the oxygen scavenging film is coated on the exterior layer or the interior layer.
